(19) United States
(12) Patent Application Publication
(10) Pub. No.: US 2015/0095250 A1
(43) Pub. Date: Apr. 2, 2015

(54) SUPPORTING INFORMATION TRANSFER DURING ORGANIZATIONAL CHANGES

(71) Applicant: International Business Machines Corporation, Armonk, NY (US)

(72) Inventors: Jennifer Lai, Brighton (AU); Jie Lu, Hawthorne, NY (US); Shimei Pan, Armonk, NY (US); Marcel C. Rosu, Ossining, NY (US); Zhen Wen, Springfield, NJ (US)

(73) Assignee: International Business Machines Corporation, Armonk, NY (US)

(21) Appl. No.: 14/042,114

(22) Filed: Sep. 30, 2013

(51) Int. Cl. G06Q 10/10; G06F 17/30

(52) U.S. Cl. CPC G06Q 10/105; G06F 17/30598
USPC 705/320

(57) ABSTRACT

A method of modeling a user includes performing a role-based classification of tangible interactions involving the user performed via a computer system of an organization, creating a collection of role-specific interactions, creating, from the collection of role-specific interactions, a plurality of role-specific models of the user, wherein the plurality of role-specific models constitute a user model of the user, outputting one or more of the role-specific models to a different user model associated with a different user, and consolidating the output one or more of the role-specific models with a second plurality of role-specific models of the different user model within the different user model.

### BACKGROUND

The present invention relates to methods of modeling users and their interactions, and more particularly, to methods of identifying a role of a user and selectively transferring role-related information from one user to another.

Job or position changes are frequent among knowledge workers. These changes may be between businesses or within the same business. Each job has one or more roles within the business associated with it, which are all performed by the person holding the job. In addition to these roles, the person holding a job can perform one or more roles using unique skills, such as EMS responder at the work location, or translator for a certain language or recruiter for an alma mater school.

The roles that a knowledge worker plays drive the interactions with other people. These interactions include, but are not limited to, email exchanges, instant messaging logs, file transfers (through email or other tools), phone calls made with the computer's soft phone and the related address book and voice messages, and calendar entries. Information captured by these interactions is often stored in digital records that are grouped automatically by the implicit rules of the tools used. For example, an email and calendar tool may group its records by record type (e.g., email vs. calendar) and date. The existence of search and browsing support (e.g., search/browse by date, person, subject keywords) in these tools discourages workers from manually organizing their records. Even when workers group the records by topic (e.g., a team project), such as filing all project-related emails in the same folder or storing files documenting the project in the same directory, workers rarely establish more than a weak association between the email folder and the file directory, typically by using similar folder and directory names.

When a worker (OLD) leaves a job, the job is often assumed by another worker (NEW) who has little or no context of what has transpired before. Information transfer from OLD to NEW is typically accomplished by one of the two approaches: 1) OLD provides documentations and records of all relevant interactions to NEW, or 2) NEW gains access to all of OLD's records. One problem with the first approach is that OLD may very likely fail to produce comprehensive documentation or provide a complete set of all relevant records. One problem with the second approach is that it is often non-trivial and very time-consuming for NEW to manually sift through a large number of records and determine what is needed for or what is relevant to various situations s/he may encounter while conducting work related to each of the multiple roles she assumes for the job.

### BRIEF SUMMARY

According to an exemplary embodiment of the present disclosure, a method of modeling a user includes performing a role-based classification of tangible interactions involving the user performed via a computer system of an organization, creating a collection of role-specific interactions, creating, from the collection of role-specific interactions, a plurality of role-specific models (RSUMs) of the user, wherein the plurality of RSUMs constitute a user model of the user, outputting one or more of the RSUMs to a different user model, and consolidating the output one or more of the RSUMs with a second plurality of RSUMs of the different user model within the different user model.

According to an exemplary embodiment of the present disclosure, a computer program product for modeling a user includes a computer readable storage medium having computer readable program code embodied therewith, the computer readable program code including computer readable program code configured to perform a role-based classification of interactions involving the user, computer readable program code configured to create a collection of role-specific interactions, computer readable program code configured to create, from the collection of role-specific interactions, a plurality of role-specific models of the user, wherein the plurality of role-specific models constitute a user model of the user, computer readable program code configured to output one or more of the role-specific models to a different user model associated with a different user, and computer readable program code configured to consolidate the output one or more of the role-specific models with a second plurality of role-specific models of the different user model within the different user model.

### BRIEF DESCRIPTION OF THE DRAWINGS

FIG. 1 illustrates a representation of an overall user-model including a plurality of role-specific models according to an exemplary embodiment of the present disclosure;

FIG. 2 illustrates a representation of a user model specific to a community volunteer role according to an exemplary embodiment of the present disclosure;

FIG. 3 illustrates a representation of a user model specific to a conference reviewer role according to an exemplary embodiment of the present disclosure;

FIG. 4 is a flow diagram illustrating a method of building a user model including a plurality of role-specific models according to an exemplary embodiment of the present disclosure;

FIG. 5 is a flow diagram illustrating a method for training a role classifier and inferring a role related to a current message according to an exemplary embodiment of the present disclosure;

FIG. 6 describes the process of inferring a topic or a plurality of topics from a current message based on role-specific user models and updating the models with new topic and role according to an exemplary embodiment of the present disclosure;

FIG. 7 describes the process of outputting role-specific user models according to an exemplary embodiment of the present disclosure;

FIG. 8 describes the process of consolidating a first user's model (original) with a second user's model (acquired) during information transfer from the second user to the first user according to an exemplary embodiment of the present disclosure; and

FIG. 9 is a diagram of a computer system configured to execute methods according to an exemplary embodiment of the present disclosure.

### DETAILED DESCRIPTION

Exemplary embodiments of the present disclosure are directed to methods of modeling knowledge workers and their interactions. According to an embodiment of the present disclosure, a role of a user, e.g., a knowledge worker, is identified from the user's interaction records, and the collection of records related to the role is selectively transferred to another user.

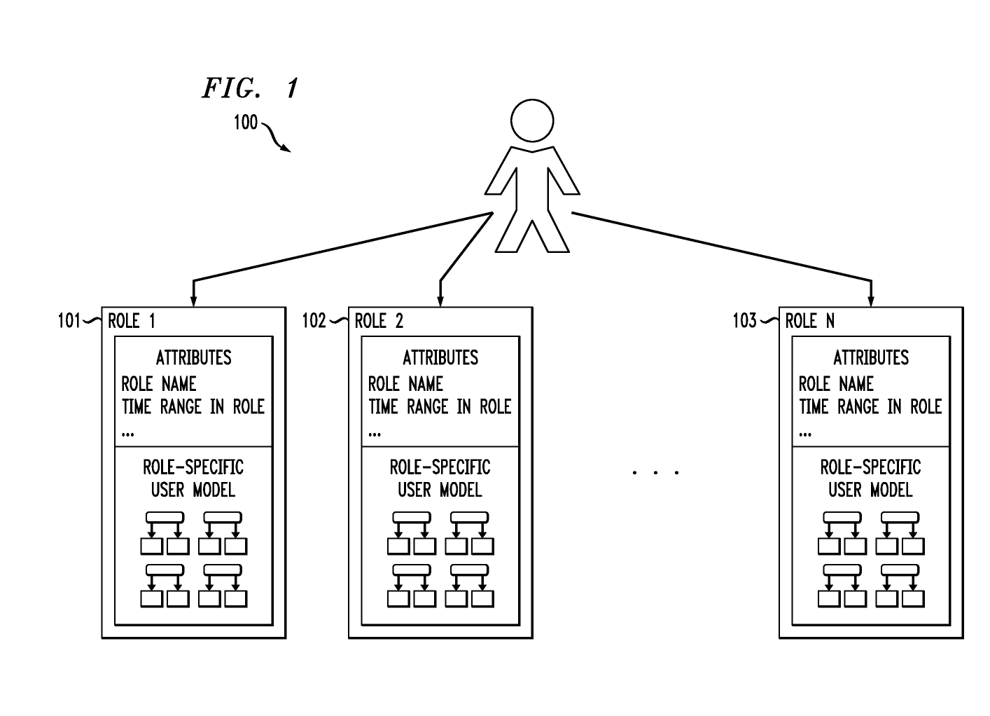

FIG. 1 illustrates an exemplary representation of an overall model 100 of a user incorporating. The overall model contains multiple role-specific user models (101-103) each corresponding to a particular role the user performs for a job. Each of these roles can be determined manually by the user or automatically by a system based on the records associated with this user.

Each role-specific user model (101-103) may contain role-related attributes such as the name of the role and the time range of the user in this role, and a topic-model based representation of the user's pair-wise interactions in this role with other people. According to some exemplary embodiments of the present disclosure, temporal information of the user is imported into the user model, wherein the temporal information includes a past role, a past job, a past team and/or a past project. In some examples, each role-specific user model is represented as a multi-tiered representation encoding a plurality of topic models (see for example, U.S. Patent Application publication 2012/0209871, filed Feb. 10, 2011, entitled Automated Contextual Information Retrieval Based On Multi-Tiered User Modeling And Dynamic Retrieval Strategy). Each topic model represents one or more topics derived from the aggregate content of the user's interaction in a particular role with a specific person or group (e.g., role-specific pair-wise). Furthermore, an exemplary role-specific user model encodes multiple tiers of information to represent the user's information at different granularities.

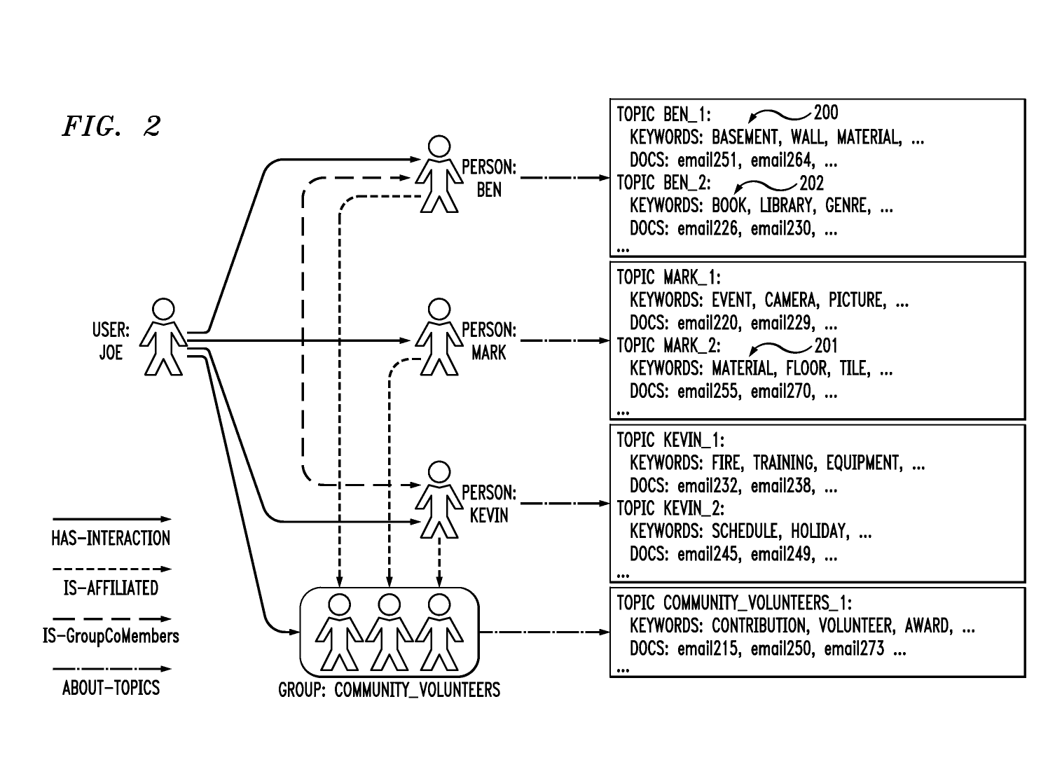

FIG. 2 illustrates an exemplary role-specific model of a user named Joe in the role of community volunteer. The role includes four topic models, each of which corresponds to the topics contained in Joe's interaction with Ben, Mark, Kevin, and the group of community volunteers respectively.

In this example, Ben and Joe both volunteer with an organization building homes for people in need. They also work together creating a community book club. In this context, they exchange emails about home construction (see 200) and books (see 202). Further, Mark is Joe's friend who works for a supplier of building materials, and Joe consults with Mark about the materials used for building houses (see 201). Joe and Mark also talk about taking and sharing pictures of community events. Joe is planning to become a volunteer firefighter and Kevin is the chief of the fire department in Joe's town.

The topics Joe discussed with each of his contacts may overlap. For example, Joe is discussing home construction with Ben and Mark, but not with Kevin (see for example, 200-201).

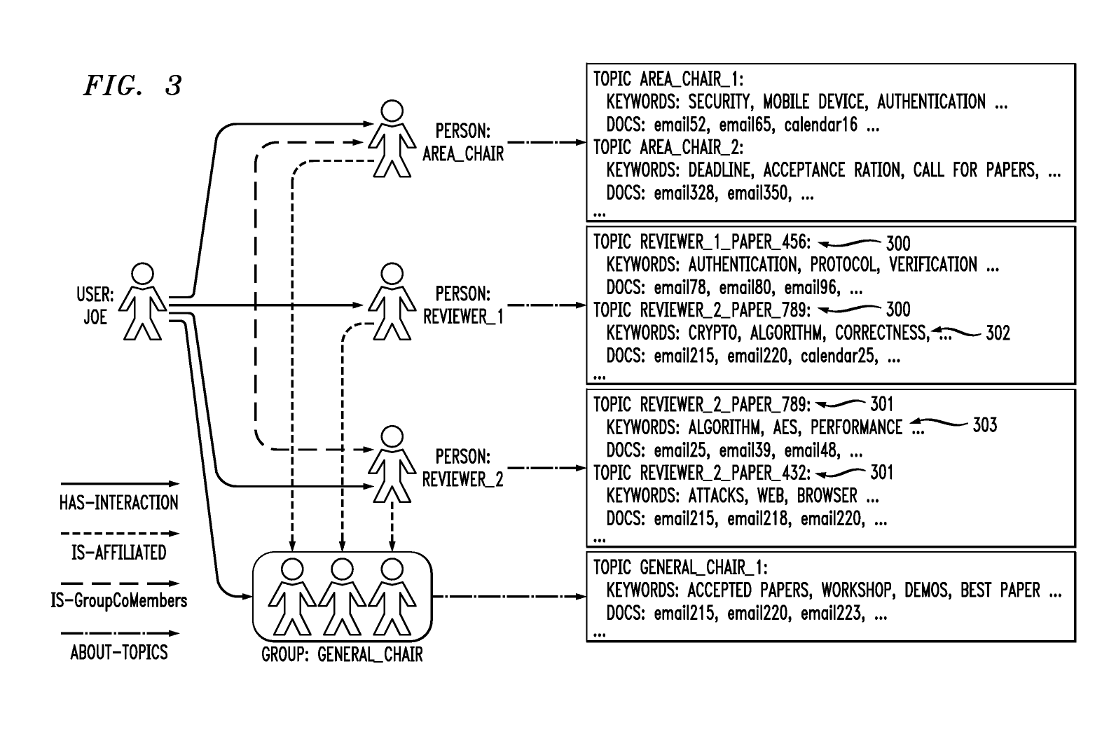

FIG. 3 illustrates another role-specific model of Joe. The role here is conference reviewer/program committee member. For this role, Joe interacted with a different list of people on different topics compared with his contacts as a community volunteer:
Joe and Reviewer 1 were both assigned to review papers 456 and 789 (see 300).
Joe and Reviewer 2 were both assigned to review papers 789 and 432 (see 301).
   The topics covered in Joe's interactions with Reviewer 1 and Reviewer 2 are different, even for the common paper (paper 789) they reviewed. Reviewer_{—}1 is more focused on the formal aspects of the paper, such as correctness 302, while Reviewer_{—}2 is more focused on the practical ones, such as performance 303.

According to an exemplary embodiment of the proposed disclosure, a system determines or knows about the various roles played by a single user (e.g. manager, research-relationship contact person, external client relationship manager, taskforce chair, external conference associate chair, etc.). The system obtains user roles through inference, by being taught the roles, or a combination thereof. One or more role-specific user models can be exported by a first user to a second user to facilitate information transfer between the first user and the second user when the second user takes over the first user's job and assumes the roles of the first user in this job.

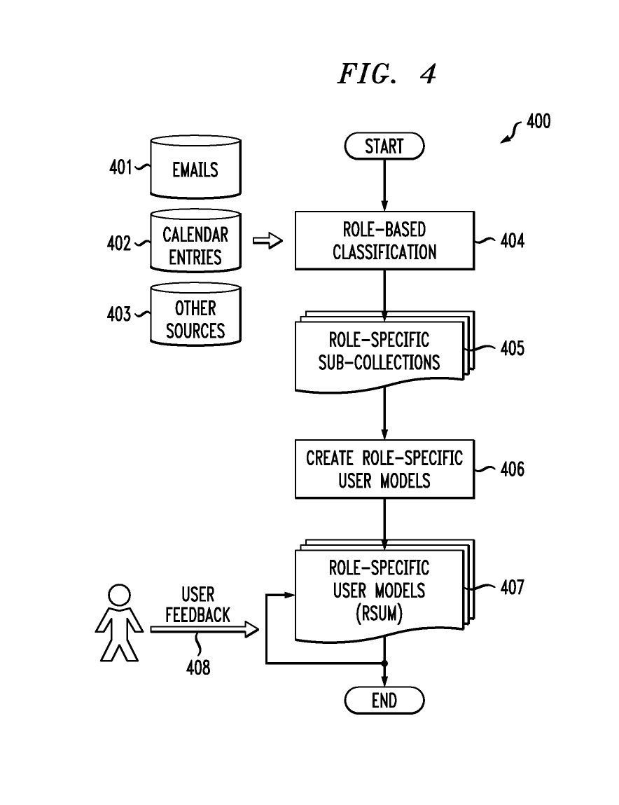

FIG. 4 is a flow diagram illustrating a method 400 for creating a user model incorporating features of the present disclosure from different data sources. Theses data sources include emails 401, calendars 402, etc. 403. At block 404, a role-based classification is performed to classify the source documents (emails 401, calendars 402, etc. 403) into one or more role-specific sub-collections 405. This process can be done manually (e.g., a user files emails into different folders, where each folder is related to a specific role) or automatically (e.g. using machine learning to train an automated role classifier to perform the task). At block 406, for each sub-collection, a role-specific user model 407 is created based on the documents in that sub-collection. According to some exemplary embodiments of the present disclosure, sub-collections and role-specific user models are associated in a one-to-one relationship. In some examples, the technology described in the U.S. Patent Application publication 2012/0209871 may be used to build such role-specific user models. More particularly, based on the basic, aggregate, and derived information encoded in a role-specific user model, multiple topic models are created and stored in the role-specific user model. Each topic model is created based on the aggregate content of the user's interaction within a specific interaction scope. An interaction scope can be an email thread with multiple messages, the interaction with a single person/group, or the user's overall interaction with other entities (e.g., people, users, groups and organizations) as a whole. A topic model associated with a thread represents the topics discussed in this thread. A topic model associated with a person or group reflects the user's topics of interest specific to this person or group. A general topic model derived from the aggregation of the user's interaction with all others represents the user's overall areas of work. The use of multiple topic models enables a user's topics of interest to be represented at a finer granularity, which yields more accurate inference of the user's context-sensitive information needs, thus resulting in higher relevancy of the retrieved content.

Here, each topic model contains a set of topics. In an exemplary embodiment, each topic is associated with two types of information: the probability of a word given this topic for all the words, and the probability of this topic given a message for all the messages in the associated interaction scope. The former probability provides a list of representative keywords that describe the topic, while the latter provides a list of messages that are strongly associated with the topic. Topics are derived from content based on statistical topic models. At 408, a user can provide feedback to help refine the role-specific user model.

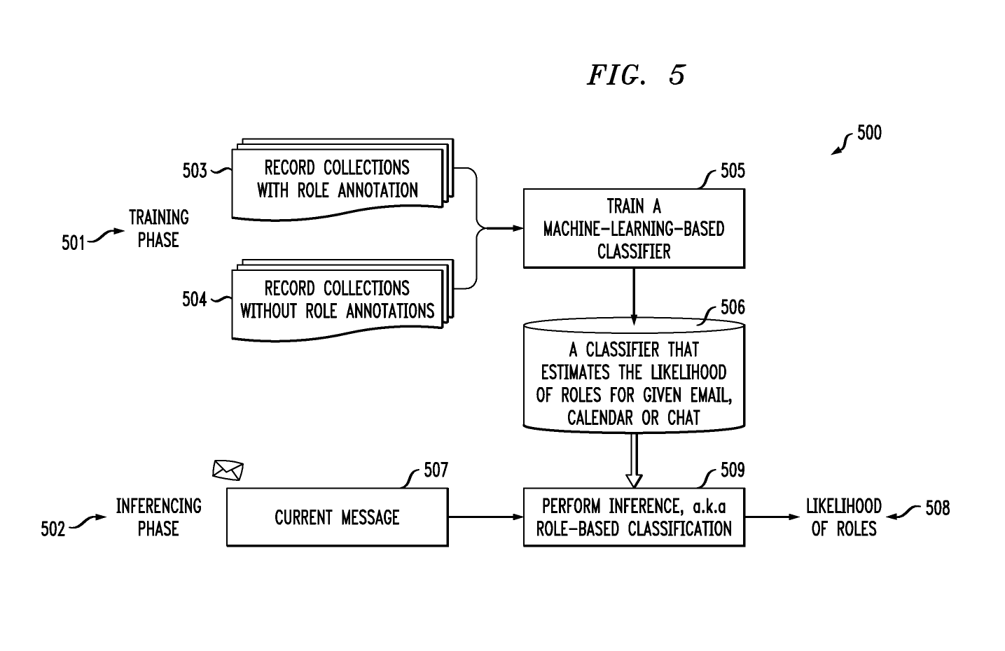

FIG. 5 is a flow diagram illustrating a method 500 for training a role classifier and inferring a role related to an incoming message. The goal of role inference is to determine which one or more roles are related to a particular message so corresponding role-specific user models can be used to further process the message to determine topics. The topic information can be used to facilitate automatic support in information seeking activities (e.g., search, browse, retrieve information relevant to context). According to FIG. 5, role inferencing 500 includes a training phase 501 and an inferencing phase 502. In the training phase 501, record collections with role annotations 503 or without role annotations 504 are used by block 505 as training data to learn a role classifier 506 using a supervised machine learning method for 503, or an unsupervised machine learning method for 504, or a semi-supervised machine learning method using both 503 and 504. The input 507 of the role classifier 506 is a representation of features extracted from the metadata and text of the message (e.g. an email, calendar entry, or chat), and the output 508 is the likelihood of each role. Once the role classifier 506 is learned, during the inferencing phase 502, given a current message 507, the role classifier 506 is used by block 509 to determine how likely this message is related to each role based on the features extracted from the message.

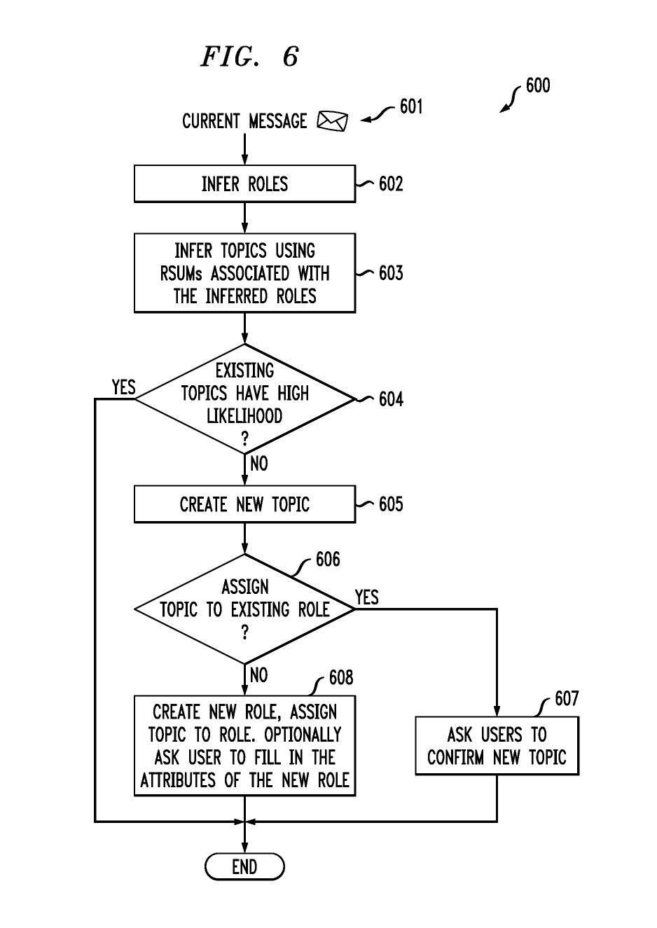

FIG. 6 illustrates an exemplary method 600 of inferring a topic or a plurality of topics from a current message based on role-specific user models and updating the models with new topic and role. New topics can appear during interactions with the same group of users or with new ones. The system assigns the new topic to an existing role, if appropriate, or creates a new role for this topic. Optionally, the user is requested to confirm the new topic or the new role.

More particularly, referring to FIG. 6, the role classifier 506 is used to infer roles related to a message 601 at block 602. Topics are inferred using the RSUMs associated with the inferred roles at block 603. The method evaluates whether one or more existing topics have high likelihood at decision block 604 and if not a new topic is created at block 605. In the alternative, if one or more existing topics have sufficiently high likelihood at decision block 604 the process outputs the topic(s) that has/have high likelihood and ends. Upon creating a new topic at 605, the newly created topic can be assigned to one of the inferred roles at decision block 606. If the topic is assigned at 606 a user is optionally asked to confirm the new topic at 607. In the alternative, if the topic is not assigned to an existing role at decision block 606, the topic is assigned to the new role at 608. At block 608 a user can be asked to fill in the attributes of the new role. Following block 607 or block 608, the process outputs the new topic and ends.

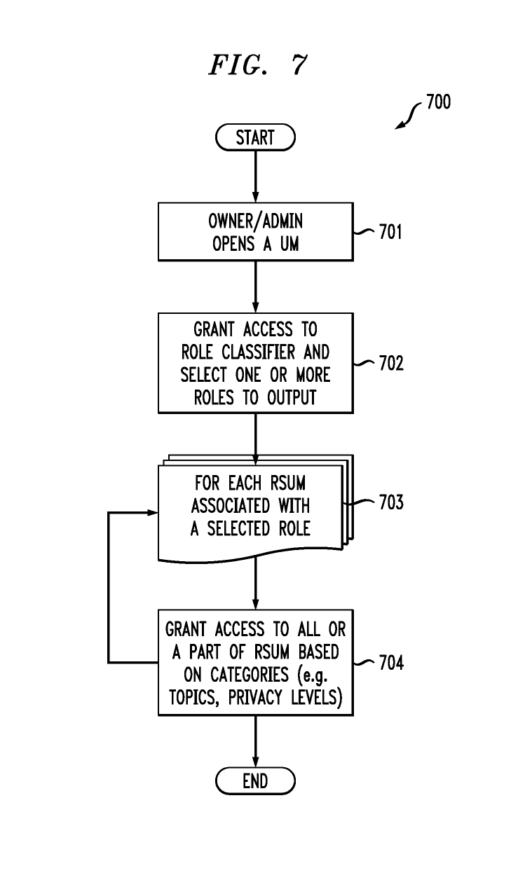

FIG. 7 illustrates an exemplary method that allows users to share one or more role-specific user models with others explicitly by interacting with the system User Interface (UI). Moreover, it is also possible to share a portion of a role-specific user model based on different criteria such as topics and privacy levels.

More particularly, referring to FIG. 7, at block 701 an administrator or user opens a user model (UM) of this user, and at block 702 the admin/user grants access the user-specific role classifier and selects one or more roles for which the associated RSUMs are to be shared. At blocks 703-704, for each RSUM associated with a selected role, access is granted to all or a part of the RSUM based on categories (e.g., topics, privacy levels, etc.).

According to some embodiments of the present disclosure, shared user models can be leveraged by applications to provide automatic support for a user's information seeking tasks when s/he assumes the job responsibilities of another user. For example, given a current message, method 600 can be applied to each of the user models (using corresponding role classifiers) to determine the best topic(s) of this message. If the current message is about a topic in an acquired user model, relevant records from the acquired user model are retrieved and presented to the user so s/he doesn't need to manually identify which records are relevant in current context.

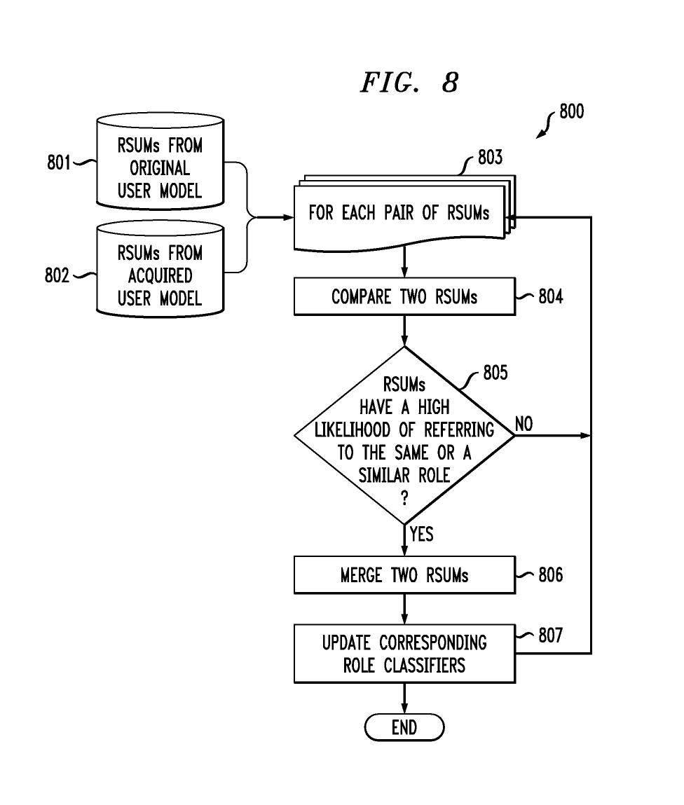

When a user takes over the job of another user, part of his/her new job responsibilities may overlap with his/her current ones. According to some exemplary embodiments of the present disclosure, two or more role-specific user models can be compared in order to determine whether an overlap exists. In some embodiments of the present disclosure, overlap is determined based on a likelihood that the two or more role-specific user models refer to a same or a similar role (e.g., according to a probability). In the case where an overlap is determined, the two or more role-specific user models are merged. FIG. 8 illustrates an exemplary method that consolidates an original user model and an acquired user model and merges the RSUMs in the original model and those in the acquired model if there is overlap between them.

More particularly, referring to FIG. 8, for each pair of RSUMs 803 (one selected from the original user model 801 and the other from the acquired model 802) the two RSUMs are compared at block 804 to determine the likelihood that they refer to the same or a similar role. The likelihood can be calculated based on the number or percentage of similar topics in the two RSUMs, where topic similarity is determined by comparing the distance between topic representations. The decision block 805 determines whether the likelihood is sufficiently high, if so, the two RSUMs are merged at block 806 and a consolidated role is created. At block 807, role classifiers associated with the original user model and the acquired user model are updated to point to the consolidated role. The two role classifiers can also be merged into a single role classifier. The process repeats until all remaining pairs of RSUMs from the two user models are compared.

According to some exemplary embodiments of the present disclosure, a user model is input into a job notification database and an opportunity is identified (e.g., a position or a project corresponding to the user model) by matching RSUMs in the user model against one or more job positions in a records database. Matches can be determined based on a comparison of vectors having dimensions (e.g., words, metadata), wherein a distance between the vectors is compared to a match threshold. In this example, a vector is a representation of the role specific model / job notification. The user is notified of the opportunity, for example, through an organization's messaging system.

According to some exemplary embodiments of the present disclosure, where the user model is implemented in an organization, organizational information available to the user is determined based on the role specific models of the user.

According to some exemplary embodiments of the present disclosure, information in the user model can be filtered (e.g., displayed) based on attributes (e.g., time range, specific roles, security level, access control level, etc.). In this exemplary embodiment, the filters can be enforced based on security clearance of a party searching for information, for example, where a user's employer can view information about their projects but the user's co-worker or reports cannot view the same information.

By way of recapitulation, a method of modeling a user includes performing a role-based classification of tangible interactions involving the user performed via a computer system of an organization (see for example, FIG. 4, block 404), creating a collection of role-specific interactions (see for example, FIG. 4, block 405), creating, from the collection of role-specific interactions, a plurality of role-specific models (RSUMs) of the user, wherein the plurality of RSUMs constitute a user model of the user (see for example, FIG. 4, block 406-407), outputting one or more of the RSUMs to a different user model (see for example, FIG. 8, blocks 801-802), and consolidating the output one or more of the RSUMs with a second plurality of RSUMs of the different user model within the different user model (see for example, FIG. 8, block 807).

The methodologies of embodiments of the disclosure may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Furthermore, it should be noted that any of the methods described herein can include an additional step of providing a system embodying the method 600 of FIG. 6, the system comprising distinct software modules embodied on one or more tangible computer readable storage media. All the modules (or any subset thereof) can be on the same medium, or each can be on a different medium, for example. The modules can include any or all of the components shown in the figures. In a non-limiting example, the modules include a first module that infers roles (see for example, FIG. 6: 602), a second module that infers topics using RSUMs associated with the inferred roles (see for example, FIG. 6: 603); a third module that assesses the topics to create new topics (see for example, FIG. 6: 604-605); and a fourth module that assigns topics to existing roles and creates new roles (see for example, FIG. 6: 606 and/or 608). Further, a computer program product can include a tangible computer-readable recordable storage medium with code adapted to be executed to carry out one or more method steps described herein, including the provision of the system with the distinct software modules.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

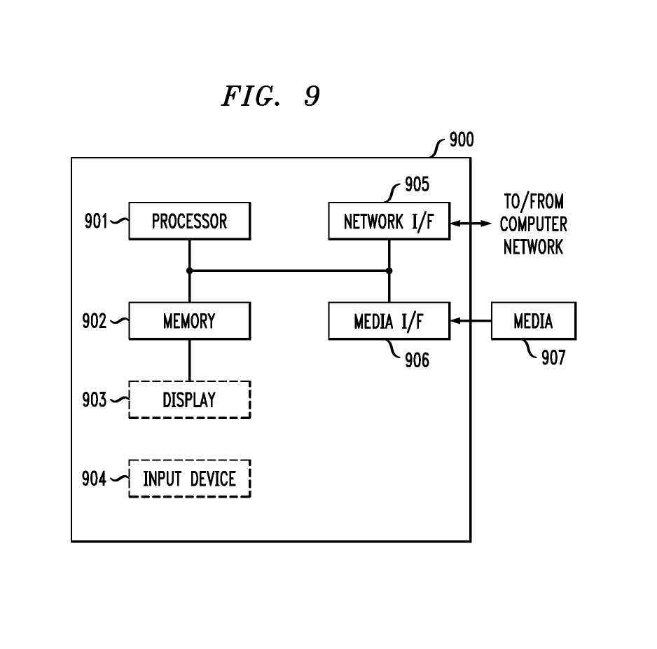

For example, FIG. 9 is a block diagram depicting an exemplary computer system for modeling users and their interactions in a process or system according to an embodiment of the present disclosure. The computer system shown in FIG. 9 includes a processor 901, memory 902, display 903, input device 904 (e.g., keyboard), a network interface (I/F) 905, a media IF 906, and media 907, such as a signal source, e.g., camera, Hard Drive (HD), external memory device, etc.

In different applications, some of the components shown in FIG. 9 can be omitted. The whole system shown in FIG. 9 is controlled by computer readable instructions, which are generally stored in the media 907. The software can be downloaded from a network (not shown in the figures), stored in the media 907. Alternatively, a software downloaded from a network can be loaded into the memory 902 and executed by the processor 901 so as to complete the function determined by the software.

The processor 901 may be configured to perform one or more methodologies described in the present disclosure, illustrative embodiments of which are shown in the above figures and described herein. Embodiments of the present disclosure can be implemented as a routine that is stored in memory 902 and executed by the processor 901 to process the signal from the media 907. As such, the computer system is a general-purpose computer system that becomes a specific purpose computer system when executing the routine of the present disclosure.

Although the computer system described in FIG. 9 can support methods according to the present disclosure, this system is only one example of a computer system. Those skilled of the art should understand that other computer system designs can be used to implement the present invention.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to a multi-core processor that contains multiple processing cores in a processor or more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the disclosure is not limited to those precise embodiments, and that various other changes and modifications may be made therein by one skilled in the art without departing from the scope of the appended claims.

What is claimed is:

1. A method of modeling a user comprising:
performing a role-based classification of tangible interactions involving the user performed via a computer system of an organization;
creating a collection of role-specific interactions;
creating, from the collection of role-specific interactions, a plurality of role-specific models of the user, wherein the plurality of role-specific models constitute a user model of the user;
outputting one or more of the role-specific models to a different user model associated with a different user; and
consolidating the output one or more of the role-specific models with a second plurality of role-specific models of the different user model within the different user model.

2. The method of claim 1, further comprising:
comparing consolidated role-specific models of the different user model to determine at least one overlap between at least two of the consolidated role-specific models; and
merging the at least two of the consolidated role-specific models determined to overlap.

3. The method of claim 2, wherein the merging is based upon a likelihood that the at least two consolidated role-specific models refer to a same or a similar role.

4. The method of claim 1, further comprising determining at least one role to the user from the tangible interactions.

5. The method of claim 4, wherein each user is associated with one user model, and each user model includes one or more role-specific models each corresponding to one role of the user.

6. The method of claim 1, wherein each of the user model and the different user model is implemented in an organization, the method further comprising:
receiving data transferring a role within the organization between the user and the different user; and
updating the different user model transferring information from the user model to the different user model.

7. The method of claim 1, further comprising:
exporting data from the user model; and
importing the data from the user model into the different user model.

8. The method of claim 7, wherein the data includes one of the user model and at least one of the role-specific user models of the user model.

9. The method of claim 7, wherein the data includes a portion of at least one of the role-specific user models of the user model, wherein the portion includes data associated with at least one of the tangible interactions.

10. The method of claim 1, further comprising:
inputting the user model into a job notification database;
identifying an opportunity including one of a position and a project corresponding to the user model; and
notifying the user of the opportunity.

11. The method of claim 1, wherein the user model is implemented in an organization, the method further comprising determining organizational information available to the user based on the plurality of role specific models of the user.

12. The method of claim 1, further comprising importing temporal information of the user into the user model, wherein the temporal information includes at least one of a past role, a past job, a past team and a past project.

13. The method of claim 1, further comprising:
filtering information in the user model; and
displaying filtered portions of the information.

14. A computer program product for modeling a user comprising:
a computer readable storage medium having computer readable program code embodied therewith, the computer readable program code comprising:
computer readable program code configured to perform a role-based classification of interactions involving the user;
computer readable program code configured to create a collection of role-specific interactions;
computer readable program code configured to create, from the collection of role-specific interactions, a plurality of role-specific models of the user, wherein the plurality of role-specific models constitute a user model of the user;
computer readable program code configured to output one or more of the role-specific models to a different user model associated with a different user; and
computer readable program code configured to consolidate the output one or more of the role-specific models with a second plurality of role-specific models of the different user model within the different user model.

15. The computer program product of claim 14, further comprising:
computer readable program code configured to compare consolidated role-specific models of the different user model to determine at least one overlap between at least two of the consolidated role-specific models; and
computer readable program code configured to merge the at least two of the consolidated role-specific models determined to overlap.

16. The computer program product of claim 15, wherein the merging is based upon a likelihood that the at least two consolidated role-specific models refer to a same or a similar role.

17. The computer program product of claim 14, further comprising computer readable program code configured to determine at least one role to the user from the tangible interactions.

18. The computer program product of claim 14, wherein each of the user model and the different user model is implemented in an organization, the method further comprising:
computer readable program code configured to receive data transferring a role within the organization between the user and the different user; and
computer readable program code configured to update the different user model transferring information from the user model to the different user model.

19. The computer program product of claim 14, further comprising:
computer readable program code configured to export data from the user model; and
computer readable program code configured to import the data from the user model into the different user model.

20. The computer program product of claim 14, further comprising:
computer readable program code configured to input the user model into a job notification database;
computer readable program code configured to identify an opportunity including one of a position and a project corresponding to the user model; and
computer readable program code configured to notify the user of the opportunity.

21. The computer program product of claim 14, wherein the user model is implemented in an organization, the computer readable program code further comprising computer readable program code configured to determine organizational information available to the user based on the plurality of role specific models of the user.

22. The computer program product of claim 14, further comprising computer readable program code configured to import temporal information of the user into the user model, wherein the temporal information includes at least one of a past role, a past job, a past team and a past project.

23. The computer program product of claim 14, further comprising:
computer readable program code configured to filter information in the user model; and
computer readable program code configured to display filtered portions of the information.
